(19) United States
(12) Patent Application Publication
(10) Pub. No.: US 2010/0146499 A1
(43) Pub. Date: Jun. 10, 2010

(54) Controlling Access to Electronic Devices by Meeting Invitees

(75) Inventors: Christopher L. Bush, Austin, TX (US); Didier Garcia, Miami, FL (US); Joshua F. Nedelka, Meriden, CT (US); Mark Rutenburg, Newington, CT (US)

Correspondence Address: IBM CORP (AP);C/O AMY PATTILLO, P. O. BOX 161327, AUSTIN, TX, 78716, US

(73) Assignee: INTERNATIONAL BUSINESS MACHINES CORPORATION, ARMONK, NY (US)

(21) Appl. No.: 12/332,071

(22) Filed: Dec. 10, 2008

(51) Int. Cl. H04L 9/32; G06F 15/16; G06F 9/445

(52) U.S. Cl. 717/178; 709/204; 709/224; 726/1; 726/4

(57) ABSTRACT

A meeting manager specifies controlled access to the use of an electronic device by sending a meeting request to at least one invitee, wherein the meeting request specifies access rights to control use during the meeting of least one feature of a plurality of features of at least one electronic device associated with the at least one invitee. The meeting manager requires the at least one invitee accept the access rights specified in the meeting request for controlling use at the at least one electronic device in order for the invitee to accept the meeting request.

### BACKGROUND

1. Technical Field

The present invention relates in general to restricted use of an electronic device, and more specifically to specifying controlled access to use of an electronic device by meeting invitees during a meeting.

2. Description of the Related Art

With the prevalence of portable electronic devices, including laptops and personal communication devices, within the workplace and other places where people meet, there are increasing ways in which a person may remain connected and quickly access information. In addition, however, with the increasing prevalence of portable electronic devices within the workplace, there are also increasing ways in which a person may be distracted by incoming messages, calendar reminders, and other information and applications available via the electronic device.

In one example, an employee may use a laptop computer during a meeting to take notes or access research. While the employee use of the laptop may provide valuable information during a meeting, the employee may also be personally distracted from giving one's full attention to the meeting by alerts to incoming messages and other information updating on the employee's laptop. In some meetings, an occasional distraction for an employee to check email or do some research during the meeting may be acceptable. In other meetings, however, a presenter may require the attention of those attending the meeting.

### SUMMARY

Therefore, in view of the foregoing, an embodiment of the invention provides a method, system, and computer program product for specifying controlled access of electronic devices. In particular, an embodiment of the invention provides a method, system, and computer program product for specifying controlled access of electronic devices by meeting invitees during a meeting.

In one embodiment of the invention, a method, system, and computer program product provide for specifying controlled access to the use of an electronic device by sending a meeting request to at least one invitee, wherein the meeting request specifies access rights to control use during the meeting of least one feature of a plurality of features of at least one electronic device associated with the at least one invitee and requiring the at least one invitee accept the access rights specified in the meeting request for controlling use at the at least one electronic device in order for the invitee to accept the meeting request.

In addition, in the embodiment, the at least one invitee is allowed to negotiate for additional access rights prior to accepting the meeting request.

Additionally, in the embodiment, a meeting manager, during a meeting specified by the meeting request receives a request from the at least one invitee for use of a particular feature not allowed by the access rights from among the plurality of features and responsive to a meeting administrator authorizing use of the particular feature during the meeting, adjusts the access rights for the electronic device to allow use of the particular feature.

In addition, in the embodiment, a meeting controller scans the at least one electronic device associated with the at least one invitee to identify the plurality of features and compares the plurality of features with a selection of features specified for control by the access rights. The meeting controller identifies a first selection of features from among the plurality of features allowed for use during the meeting according to the access rights and a second selection of features from among the plurality of features disallowed from use during the meeting according to the access rights and displays the first selection of features and the second selection of features and notifying the invitee that acceptance of the meeting request is contingent on control of the second selection of features during the meeting. The meeting controller offers a selectable option for the at least one invitee to select at least one particular feature from among the second selection of features to request to add to the first selection of features.

Additionally, in the embodiment, features controllable by access rights include network use features, application features, and hardware element features.

### BRIEF DESCRIPTION OF THE SEVERAL VIEWS OF THE DRAWINGS

The novel features believed characteristic of one or more embodiments of the invention are set forth in the appended claims. The one or more embodiments of the invention itself however, will best be understood by reference to the following detailed description of an illustrative embodiment when read in conjunction with the accompanying drawings, wherein:

FIG. 1 is a block diagram depicting one embodiment of a meeting controller for managing the scheduling of a meeting with controlled access to electronic devices by invitees during the meeting;

FIG. 2 is a block diagram illustrating one embodiment of a meeting manager for managing distribution of access rights to control use of electronic devices by invitees during a meeting;

FIG. 3 is a block diagram depicting one embodiment of a network environment for managing access rights of electronic devices during a meeting;

FIG. 4 is a block diagram illustrates an example of a computer system in which the present invention may be implemented;

FIG. 5 is a block diagram illustrating one embodiment of selectable options within a meeting requester interface for a requester to specify a meeting request with access rights for controlling use of invitee electronic devices during the meeting

FIG. 6 is a block diagram depicting one embodiment of selectable options within a meeting invitee interface for an invitee receiving a meeting request with access rights required for an invitee to accept the meeting;

FIG. 7 is a block diagram illustrating one embodiment of a selectable option within a meeting invitee interface for an invitee receiving a meeting request with specified lists of allowed and disallowed features of a particular electronic device according to the access rights specified for the meeting;

FIG. 8 is a high level logic flowchart depicting a process and program for managing a meeting requester's specification and scheduling of a meeting request;

FIG. 9 is a high level logic flowchart illustrating a process and program for a meeting manager for managing meeting requests with access rights for controlling use of electronic device during meetings; and

FIG. 10 is a high level logic flowchart depicting a process and program for managing invitee acceptance of meeting requests with access rights for controlling use of an electronic device by the invitee during the meeting.

### DETAILED DESCRIPTION

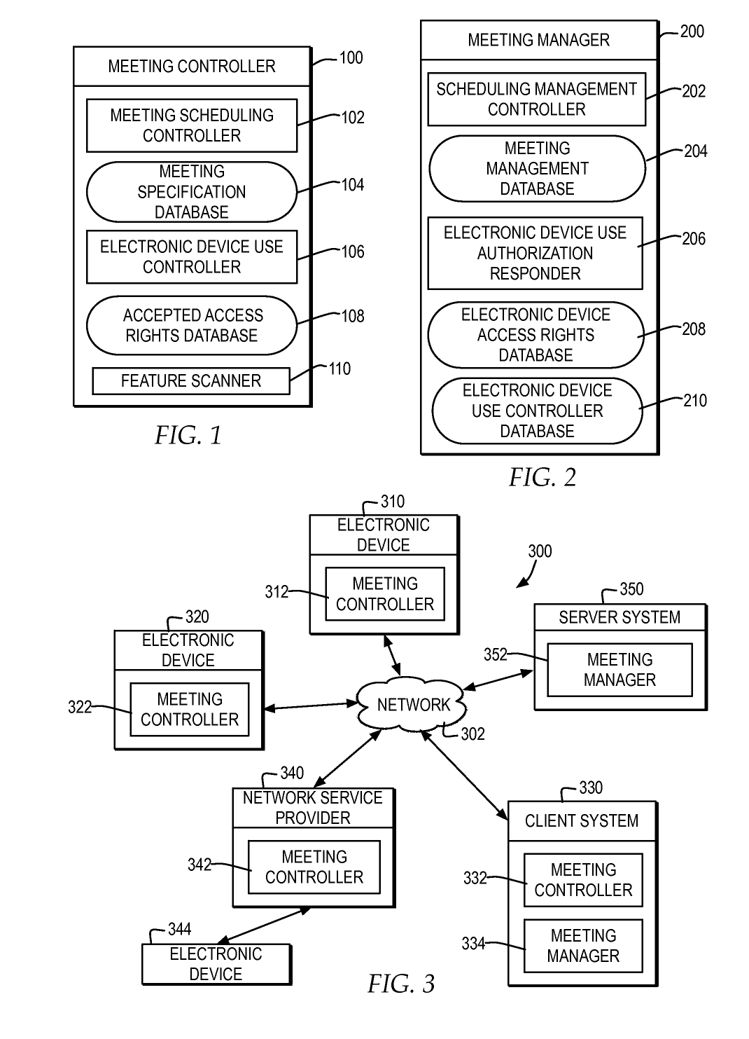

Referring now to FIG. 1, a block diagram depicts one embodiment of a meeting controller for managing the scheduling of a meeting with controlled access to electronic devices by invitees during the meeting.

In the example, a meeting controller 100 includes a meeting scheduling controller 102, a meeting specification database 104, an electronic device use controller 106, an accepted access rights database 108, and a feature scanner 110. It will be understood that meeting controller 100 may include additional or alternate components to the controllers and databases depicted and that the components of meeting controller 100 may be distributed within a single system or across multiple systems.

In one example, meeting scheduling controller 102 provides an interface and functionality for a requester to specify and send a meeting request, where the meeting request includes at least one detail about a requested meeting and access rights for controlling use of electronic devices during the meeting. Meeting scheduling controller 102 may send the meeting request via one or more types of connections to one or more systems.

The details about a meeting may include, but are not limited to, a meeting time, multiple proposed meeting times, one or more meeting locations, one or more network addresses specified for the meeting, one or more communication channels specified for the meeting, a telephone line reserved for the meeting, one or more meeting subjects, a name or identifier for one or more meeting invitees, and other information specifying the parameters of a meeting. A requester may request a meeting scheduled occur at one or more physical locations, via one or more network locations, via one or more communication channels, or a combination of locations and channels.

The access rights for placing limitations on the use of electronic devices during a meeting may include controls for restricting use of a particular feature of an electronic device, restricting use of a type of feature on an electronic device, only allowing access to one or more features of an electronic device, and other specified controls on the access rights to use electronic devices during a meeting. A feature of an electronic device may include, but is not limited to, a hardware device, an application, an operating system function, a network channel, and any other component, executable or function of an electronic device. A requester may further specify the limitations specified by access rights according to an identifier for an invitee, by type of electronic device, by meeting location, and by other criteria. For a particular invitee, a requester may specify the access rights controlling use of a particular electronic device or all electronic devices accessible to the invitee.

Meeting scheduling controller 102 may record meeting requests and scheduled meetings in meeting specification database 104. In one example, meeting scheduling controller 102 may control an interface for displaying meeting requests and scheduled meetings stored in meeting specification database 104. In one example, meeting schedule controller 102 may plug-in to a calendar interface controller (not depicted) or other application for displaying events.

In addition, in one example, meeting scheduling controller 102 provides an interface and functionality for an invitee to receive a meeting request that includes at least one detail about a meeting and access rights for controlling use of electronic devices during the meeting. Meeting scheduling controller 102 may receive the meeting request via one or more types of connections to one or more systems.

When meeting scheduling controller 102 receives a meeting request, meeting scheduling controller 102 may trigger an interface for presenting the request to an invitee or may trigger another application, such as an application which maintains and displays a calendar, to present the request to an invitee. In one example, meeting scheduling controller 102 presents the meeting request to an invitee specifying the access rights for controlling use of electronic devices during the meeting, where the invitee is required to accept the access rights to accept the meeting request. In another example, meeting scheduling controller 102 presents the meeting request to an invitee specifying the access rights for controlling use of electronic devices during the meeting with an option for the invitee to request to negotiate with the meeting requester to adjust the access rights. In particular, meeting schedule controller 102 at a requester system may receive requests for negotiation of access rights and engage in communications for negotiating the access rights with the invitee.

When an invitee accepts a meeting request, meeting scheduling controller 102 may store the accepted meeting request in meeting specification database 104 and also store a record of the invitee acceptance of the access rights for a meeting in accepted access rights database 108. Electronic device use controller 106 is then set to control use of one or more electronic devices during meeting times according to the applicable access rights in accepted access rights database 108.

In one example, when an invitee accepts the access rights specified in a meeting request the meeting request includes the rules for the access rights. Meeting scheduling controller 102 stores the rules for the access rights in accepted access rights database 108 and during the meeting, electronic device use controller 106 controls use of at least one electronic device by an invitee according to the rules for the access rights accessed from accepted access rights database 108.

In another example, when an invitee accepts the access rights specified in a meeting request, meeting scheduling controller 102 sends a record of the acceptance to a computer system implementing a meeting manager, as will be further described with reference to FIG. 2, and the acceptance also authorizes the meeting manager to download electronic device use controller 106 with specific access rights limitations, to meeting controller 100.

In yet another example, when an invitee accepts the access rights specified in a meeting request, a record of the acceptance and the network location of a server implementing a meeting manager for specifying the access rights for an electronic device during the meeting is placed in accepted access rights database 108. During the meeting, electronic device use controller 106 detects the network location of the server, sends a request to the server for access rights for the electronic device for the meeting time, and periodically queries the server for updated access rights for the electronic device during the meeting.

Electronic device use controller 106, in one example, is triggered to control use of an electronic device when the current time is within the parameters of the scheduled meeting time for the meeting. In another example, electronic device use controller 106 is triggered by network communication from another system. In addition, in other examples, electronic device use controller 106 may include additional or alternate rules for triggering controlled use of an electronic device during a meeting or may receive additional or alternate types of signals for triggered controlled use of an electronic device during a meeting.

In addition, meeting controller 100 may include a feature scanner 110. Feature scanner 110 may scan one or more electronic devices associated with an invitee to detect the features available from each applicable electronic device. In one example, meeting scheduling controller 102 may compare the actual features of an electronic device with the features restricted in the access rights for a meeting request and dynamically adjust the access rights presented to an invitee to only list the actual features available to the invitee which a meeting request restricts. In another example, meeting schedule controller 102 may list all the features of a detected electronic device by feature scanner 110 and designate whether each feature is allowed or disallowed by the access rights specified in a meeting request. Feature scanner 110 may scan one or more electronic devices in different ways, as will be understood by someone with skill in the art, based on the device. In one example, feature scanner 110 may request a configuration file from an operating system of an electronic device and detect features of the electronic device from the configuration file. In another example, feature scanner 110 may detect a model number of an electronic device and access a list of standard features for the model number from a database.

With reference now to FIG. 2, a block diagram depicts one embodiment of a meeting manager for managing distribution of access rights to control use of electronic devices by invitees during a meeting.

In the example, a meeting manager 200 includes a scheduling management controller 202, a meeting management database 204, an electronic device use authorization responder 206, an electronic device access rights database 208, and an electronic device use controller database 210. It will be understood that meeting manager 200 may include additional or alternate components to the controllers and databases depicted and that the components of meeting manager 200 may be distributed within a single system or across multiple systems.

In the example, a scheduling management controller 202 manages receipt, distribution, confirmation, scheduling, organization, and other transmissions of meeting requests and scheduled meetings, which may be recorded and stored within meeting management database 204. Meeting management database 204 may include the current schedules, scheduling availability, scheduling preferences, scheduling restrictions, and other scheduling information for one or more users, such that scheduling management controller 202 is able to identify and suggest times available for a meeting for multiple users and scheduling management controller 202 is able to coordinate the reservation, scheduling, and calendaring of meetings between multiple users.

In addition, in the example, an electronic device use authorization responder 206 manages the scheduling and application of electronic device access rights in association with meetings and maintains requested and accepted meeting access rights in electronic device access rights database 208. Electronic device use authorization responder 206 may detect meeting requests that include specified access rights and may direct scheduling management controller 202 to present the meeting request to the invitee with acceptance of the meeting request, contingent upon the invitee first accepting the specified access rights. Electronic device use authorization responder 206 may detect an invitee's acceptance of a meeting request with specified access rights and may specify and transmit or download a controller or module from electronic device use controller database 210 to the invitee's electronic devices, such as electronic device use controller 106, that when installed and executed on the invitee's electronic device, will enforce the access rights for a meeting specified in electronic device use controller database 208. In addition, electronic device use authorization responder 206 may detect an invitee's acceptance of a meeting request with specified access rights and may send specified rules for the access rights to electronic device use controller 106 to direct electronic device use controller 106 to enforce the access rights.

In managing a meeting request acceptance by an invitee, electronic device use authorization responder 206 may receive a request from an invitee to adjust the access rights. Electronic device use authorization responder 206 distributes the request to adjust the access rights to the meeting requester. Electronic device use authorization responder 206 either receives a response from a meeting requester authorizing or declining the adjustment request, or after a timeout period automatically declines the adjustment request, and sends the response to the invitee.

In setting up a meeting, a meeting requester may specify dynamic access rights. For example, dynamic access rights may include limitations which are contingent upon events that may occur prior to or during the meeting. In another example, dynamic access rights may be access rights that a meeting participant or meeting administrator may selectively adjust during the meeting. In one example, to enforce dynamic access rights, electronic device use authorization responder 206 may detect an invitee's acceptance of a meeting request with dynamic access rights, store the acceptance and specified dynamic access rights in electronic device access rights database 208, detect requests from electronic devices during a meeting for the current state of the dynamic access rights, determine the current state of the dynamic access rights, and send transmissions to the electronic devices with current state of the dynamic access rights from electronic device access rights database 208. To adjust the dynamic access rights for a meeting, during the meeting, in one example, scheduling management controller 202 may provide an interface through which a user may selectively authorize or deauthorize specific access rights for specific invitees, during the meeting, and scheduling management controller 202 updates electronic device access rights database 208 with selective adjustments.

With reference now to FIG. 3, a block diagram depicts one embodiment of a network environment for managing access rights of electronic devices during a meeting. In the example, in a network environment 300, a network 302 communicatively connects multiple systems, such as electronic device 310, electronic device 320, client system 330, network service provider 340, and server system 350. Network 302 may include, but is not limited to, packet-switching networks, such as the Internet or an intranet, and telephony networks. In addition, network 302 may include routers, switches, gateways, and other hardware to enable a communication channel between electronic device 310, electronic device 320, client system 330, network service provider 340, and server system 350. Further, while in the example electronic device 310, electronic device 320, client system 330, network service provider 340, and server system 350 are depicted as communicating via network 302, in an alternate embodiment, one or more of the systems may be incorporated within network 302.

In the example, electronic device 310 includes a meeting controller 312, electronic device 320 includes a meeting controller 322, client system 330 includes a meeting controller 332, and network service provider 340 includes a meeting controller 342, where meeting controller 312, meeting controller 322, meeting controller 332, and meeting controller 342 include one or more of the components of meeting controller 100 of FIG. 1. In addition, server system 350 includes a meeting manager 352 and client system 330 includes a meeting manager 334, where meeting manager 352 and meeting manager 334 include one or more of the components of meeting controller 200 of FIG. 2.

In one example, meeting manager 352 sends a meeting request to electronic device 310 requiring an invitee to the meeting to accept access rights controlling the use of electronic device 310 in order to accept the meeting request. When the invitee accepts the meeting request, meeting manager 352 may control use of electronic device 310 according to the specified access rights in one or more ways. For example, meeting manager 352 may send the specified access rights to meeting controller 312 for meeting controller 312 to locally determine and control use of electronic device 310. In another example, meeting manager 352 may direct meeting controller 312 to restrict all functions of electronic device 310 during a meeting except for network access to meeting manager 352 to receive current access rights. In yet another example, meeting manager 352 may specify and transmit an electronic device use controller 106 to meeting controller 312 for controlling use of electronic device 310 during the meeting.

In addition, when meeting manager 352 sends a meeting request to electronic device 310 requiring an invitee to the meeting to accept access rights controlling use of electronic device 310, meeting manager 352 may permit the invitee to request to negotiate for additional or alternate access rights. In one example, via meeting controller 312, an invitee requests additional access rights and meeting manager 352 forwards the request the meeting requester via meeting controller 332. If the meeting requester authorizes the additional access rights, meeting controller 332 directs meeting manager 352 to update the access rights for the meeting request for the particular invitee and meeting manager 352 presents the meeting request with updated access rights to the invitee for acceptance via meeting controller 312.

In the example, client system 330 provides an example of a system providing both meeting controller 332 and meeting manager 334, where meeting controller 332 may provide an interface for a requester to specify meeting requests with access rights and meeting manager 334 may manage distribution and acceptance of meeting requests and enforcement of access rights. In addition, meeting controller 332 may provide an interface for an invitee to accept a meeting request with access rights, where the access rights are for use of a separate electronic device, such as electronic device 310 or electronic device 320, and meeting manager 334 manages enforcement of access rights on the applicable electronic devices.

In addition, in the example, a network service provider 340 with a meeting controller 342 provides an example where meeting controller 342 may manage enforcement of access rights on electronic device 344, by restricting the service provided by network service provider 340 to electronic device 344. In particular, network service provider 340 may provide a network service to electronic device 344 to access network 302, where network service provider 340 also implements meeting controller 342 to enforce access rights during meeting accepted by invitees, where the access rights include controlled use of the network service provided by network service provider 340. In one example, a meeting request may further restrict access rights to an area in which network service provider 340 provides access to any electronic devices, such as electronic device 344, such that when an invitee accepts the access rights specified in a meeting request, the invitee accepts meeting controller 342 controlling the access to network service by any electronic device the invitee brings into the meeting area.

To detect an electronic device brought into a meeting area, in one example, network service provider 340 may detect electronic devices brought into a meeting area by a local wireless controller of network service provider 340 detecting a network connection request from electronic devices to the local wireless controller, for a wireless connection. In another example, network service provider 340 may detect electronic devices brought into a meeting area through a device within a meeting area that scans an area for thermal signatures representing electronic devices. It will be understood that network service provider 340 may receive signals from additional and alternate types of controllers enabled to detect a presence of an electronic device during a meeting or within a meeting area.

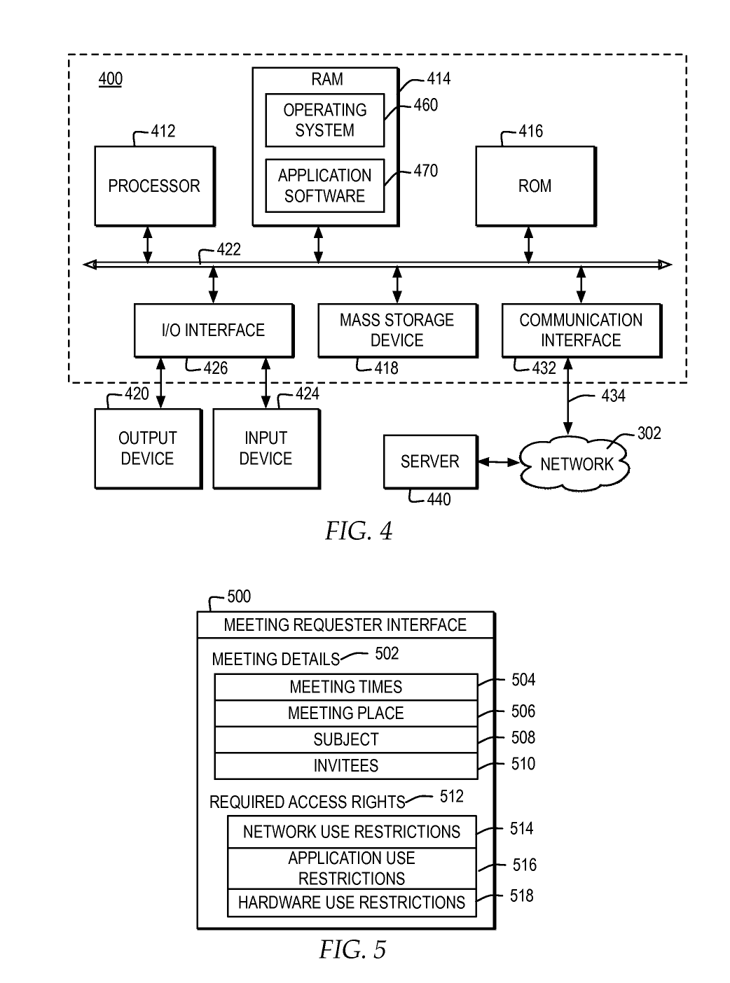

With reference now to FIG. 4, a block diagram illustrates an example of a computer system in which the present invention may be implemented. The present invention may be executed in a variety of systems and combinations of systems, made up of functional components, such as the functional components described with reference to computer system 400 and may be communicatively connected to a network, such as network 302.

Computer system 400 includes a bus 422 or other communication device for communicating information within computer system 400, and at least one processing device such as processor 412, coupled to bus 422 for processing information. Bus 422 preferably includes low-latency and higher latency paths that are connected by bridges and adapters and controlled within computer system 400 by multiple bus controllers. When implemented as a server, computer system 400 may include multiple processors designed to improve network servicing power. Where multiple processors share bus 422, additional controllers (not depicted) for managing bus access and locks may be implemented.

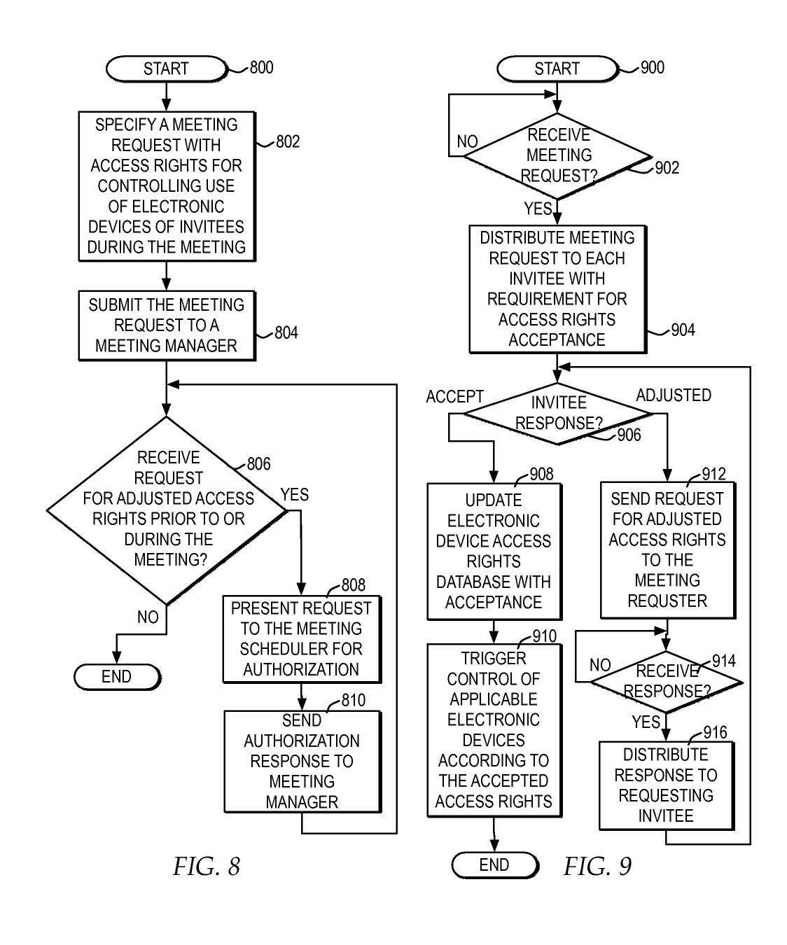

Processor 412 may be a general-purpose processor such as IBM's PowerPC (PowerPC is a registered trademark of International Business Machines Corporation) processor that, during normal operation, processes data under the control of an operating system 460, application software 470, middleware (not depicted), and other code accessible from a dynamic storage device such as random access memory (RAM) 414, a static storage device such as Read Only Memory (ROM) 416, a data storage device, such as mass storage device 418, or other data storage medium. In one embodiment, the operations performed by processor 412 may control management of content displayed on portable, content adjustable identification devices as depicted in the operations of flowchart of FIGS. 8-10 and other operations described herein. Operations performed by processor 412 may be requested by operating system 460, application software 470, middleware or other code or the steps of the present invention might be performed by specific hardware components that contain hardwired logic for performing the steps, or by any combination of programmed computer components and custom hardware components.

As will be appreciate by one skilled in the art, the present invention may be embodied as a system, method or computer program product. Accordingly, the present invention may take the form of an entirely hardware embodiment, an entirely software embodiment (including firmware, resident software, micro-code, etc) or an embodiment containing software and hardware aspects that may all generally be referred to herein as “circuit,” “module,” or “system.” Furthermore, the present invention may take the form of a computer program product embodied on any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, such as mass storage device 418, a random access memory (RAM), such as RAM 414, a read-only memory (ROM), an erasable programmable read-onlymemory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, such as computer system 400, partly on the user's computer, as a stand-alone software package, partly on the user's computer and partly on a remote computer or entirely on the remote computer or server, such as a server 440. In the latter scenario, the remote computer may be connected to the user's computer through any type of network, such as network 302, through a communication interface 432 over a network link 434, that may be connected, for example, to network 302 including a local area network (LAN) or a wide area network (WAN), or the connection may be made to an external computer (for example, through the Internet using an Internet Service Provider). Although not depicted, communication interface 432 may include software, such as device drivers, hardware, such as adapters, and other controllers that enable communication. When implemented as a server, computer system 400 may include multiple communication interfaces accessible via multiple peripheral component interconnect (PCI) bus bridges connected to an input/output controller, for example. In this manner, computer system 400 allows connections to multiple clients via multiple separate ports and each port may also support multiple connections to multiple clients.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, such as computer system 400, or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer, such as computer system 400, or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Network link 434 and network 302 both use electrical, electromagnetic, or optical signals that carry digital data streams. The signals through the various networks and the signals on network link 434 and through communication interface 432, which carry the digital data to and from computer system 300, may be forms of carrier waves transporting the information.

In addition, computer system 400 may include multiple peripheral components that facilitate input and output. These peripheral components are connected to multiple controllers, adapters, and expansion slots, such as input/output (I/O) interface 426, coupled to one of the multiple levels of bus 422. For example, input device 424 may include, for example, a microphone, a video capture device, a body scanning system, a keyboard, a mouse, or other input peripheral device, communicatively enabled on bus 422 via I/O interface 426 controlling inputs. In addition, for example, a display device 420 communicatively enabled on bus 422 via I/O interface 426 for controlling outputs may include, for example, one or more graphical display devices, audio speakers, and tactile detectable output interfaces, but may also include other output interfaces. In alternate embodiments of the present invention, additional or alternate input and output peripheral components may be added.

Those of ordinary skill in the art will appreciate that the hardware depicted in FIG. 4 may vary. Furthermore, those of ordinary skill in the art will appreciate that the depicted example is not meant to imply architectural limitations with respect to the present invention.

With reference now to FIG. 5, a block diagram illustrates one embodiment of selectable options within a meeting requester interface for a requester to specify a meeting request with access rights for controlling use of invitee electronic devices during the meeting. In the example, a meeting requester interface 500 includes selectable options for meeting details 502 and for required access rights 512.

As illustrated in the example, selectable options for meeting details 502 may include meeting times 504, meeting place 506, subject 508, and invitees 510. Meeting times 504 may include a specific meeting time, suggested meeting times, optional meeting times, and other time boundaries. Meeting place 506 may include specification of at least one of one or more physical locations and one or more network or communication channels. Subject 508 may include the subject or focus of the meeting. Invitees 510 may include specific users, a group of users, a type of user, and other user limitations. It will be understood that additional or alternate types of selectable options may be provided to a user to define meeting details 502.

In addition, as illustrated in the example, selectable options for required access rights 512 may include multiple types of restriction options. In the example, a selectable option of network user restrictions 514 may include restrictions on use of network applications, a network channel, a type of network service, security requirements for network channel use, and other limitations on network use. In addition, in the example, a selectable option of application use restrictions 516 may include restrictions on use of one or more specific applications or types of applications. In addition, in the example, a selectable option of hardware use restrictions 518 may include restrictions on use of one or more hardware features, including, but not limited to, a keyboard, mouse, display interface, printer, network adapter, power source, battery, speaker, microphone, external memory, or touchpad.

In specifying required access rights 512, a requester may further specify different sets of access rights and assign each set of access rights to one or more invitees, to one or more time periods further delineated within meeting times 504, and to one or more places further delineated within meeting place 506. In addition, in specifying required access rights 512, a requester may specify dynamic access rights which are dependent upon one or more events or which the requester may adjust during the meeting.

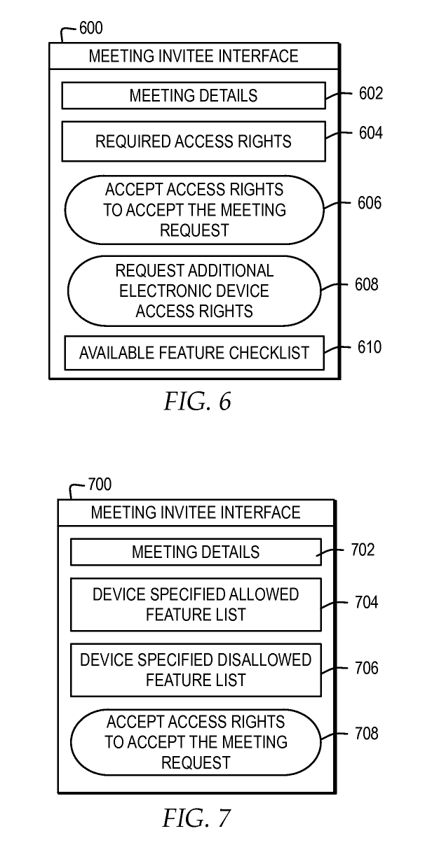

With reference now to FIG. 6, a block diagram illustrates one embodiment of selectable options within a meeting invitee interface for an invitee receiving a meeting request with access rights required for an invitee to accept the meeting. In the example, a meeting invitee interface 600 includes meeting details 602, required access rights 604, a selectable option 606 for an invitee to accept the access rights and meeting request, a selectable option 608 for an invitee to request additional or alternate electronic device access rights, and an available feature checklist 610 for displaying the available features of an electronic device.

In the example, an invitee may select selectable option 606 to accept the access rights and the meeting request. Alternatively, the invitee may select selectable option 608 to request additional electronic device access rights. If the user elects to request additional electronic device access rights, in one example, available feature checklist 610 may become a selectable list, in which a user may select additional features to add to the access rights. As requests are made for additional access rights and the requester accepts or denies the requests for additional access rights, meeting invitee interface 600 may also be updated to include a log of the requests and available feature checklist 610 may be updated to graphically distinguish the allowed and disallowed features within the access rights for the meeting.

In addition, in the example, an invitee may access meeting invitee interface 600 during a meeting and select selectable option 608. In particular, during a meeting an invitee may request additional access rights as needed to further participate in the meeting.

Referring now to FIG. 7, a block diagram illustrates one embodiment of a selectable option within a meeting invitee interface for an invitee receiving a meeting request with specified lists of allowed and disallowed features of a particular electronic device according to the access rights specified for the meeting. In the example, a meeting invitee interface 700 includes meeting details 702, a device specified allowed feature list 704, a device specified disallowed feature list 706, and a selectable option 708 for an invitee to accept the access rights and meeting request.

In particular, in the example, feature scanner 110 as described with reference to FIG. 1 may scan one or more electronic devices, to detect all the available features of each electronic device. When meeting scheduling controller 102 receives a meeting request with required access rights, meetings scheduling controller 102 compares the required access rights with the features list and generates device specified allowed feature list 704 of features an invitee is allowed to use and device specified disallowed feature list 706 of features an invitee is disallowed from using.

By displaying device specified allowed feature list 704 and device specified disallowed feature list 706, an invitee receives advance notice of the specific features of the particular electronic device that will be available. The invitee may select to accept the access rights limitations and the meeting request by selecting selectable option 606. Where the access rights for a meeting are dynamic access rights, during a meeting scheduling controller 102 may update device specified allowed feature list 704 and device specified disallowed feature list 706 within meeting invitee interface 700 as the access rights for the meeting dynamically adjust.

With reference now to FIG. 8, a high level logic flowchart depicts a process and program for managing a meeting requester's specification and scheduling of a meeting request. In the example, the process starts at block 800 and thereafter proceeds to block 802. Block 802 illustrates specifying a meeting request with access rights for controlling use of electronic devices of invitees during the meeting. Next, block 804 depicts submitting the meeting request to a meeting manager. Thereafter, block 806 illustrates a determination whether a request for adjusted access rights is received prior to or during the meeting. If a request for adjusted access rights is not received, then the process ends. If a request for adjusted access rights is received, then the process passes to block 808. Block 808 illustrates presenting the request to the meeting scheduler for authorization. Next, block 810 depicts sending the authorization response to the meeting manager, and the process returns to block 806.

Referring now to FIG. 9, a high level logic flowchart illustrates a process and program for a meeting manager for managing meeting requests with access rights for controlling use of electronic device during meetings. In the example, the process starts at block 900 and thereafter proceeds to block 902. Block 902 illustrates a determination whether a meeting request is received. If the meeting manager receives a meeting request, then the process passes to block 904. Block 904 depicts distributing meeting requests to each invitee with a requirement for acceptance of the access rights to accept the meeting request. Next, block 906 illustrates a determination when an invitee responds, what type of response is received. In the example, the responses of “accept” for accept the access rights and “adjusted” for requesting adjusted access rights are illustrated, however additional responses, such as an invitee declining a request or an invitee requesting adjustments to the meeting time, place, invitees, subject, or other meeting details, may also be received and processed.

At block 906, if an invitee responds with an acceptance, then the process passes to block 908. Block 908 depicts updating the electronic device access rights database with the acceptance. Next, block 910 illustrates triggering control of the applicable electronic devices according to the accepted access rights, and the process ends.

At block 906, if an invitee responds with an adjusted access rights request, then the process passes to block 912. Block 912 illustrates sending a request for adjusted access rights to the meeting requester. Next, block 914 depicts a determination whether a response is received to the request for adjusted access rights. When a response is received from the meeting requester, or after a timeout period, then the process passes to block 916. Block 916 illustrates distributing the response to the requesting invitee and the process returns to block 906.

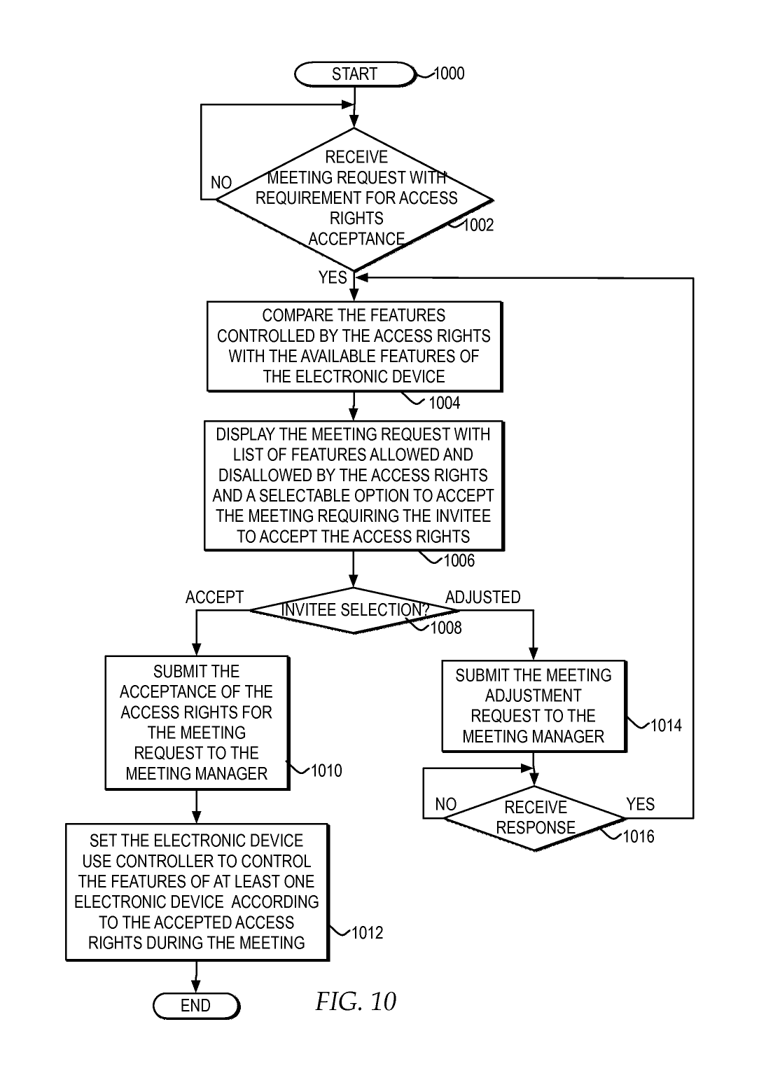

With reference now to FIG. 10, a high level logic flowchart depicts a process and program for managing invitee acceptance of meeting requests with access rights for controlling use of an electronic device by the invitee during the meeting. In the example, the process starts at block 1000 and thereafter proceeds to block 1002. Block 1002 illustrates a determination whether a meeting controller for an invitee receives a meeting request with a requirement for access rights acceptance. If the meeting controller for an invitee receives a meeting request with a requirement for access rights acceptance, then the process passes to block 1004. Block 1004 depicts comparing the features controlled by the access rights with the available features of the electronic device. Next, block 1006 illustrates displaying the meeting request with the list of features allowed and disallowed by the access rights and a selectable option to accept the meeting requiring the invitee to accept the access rights. Thereafter, block 1008 depicts a determination when an invitee makes a selection in response to the meeting request, what type of selection is received. In the example, the responses of “accept” for accept the access rights and “adjusted” for requesting adjusted access rights are illustrated, however additional responses, such as an invitee declining a request or an invitee requesting adjustments to the meeting time, place, invitees, subject, or other meeting details, may also be received and processed.

At block 1006, if an invitee responds by accepting the access rights for the meeting request, then the process passes to block 1010. Block 1010 depicts submitting the acceptance of the access rights for the meeting request to the meeting manager. Next, block 1012 illustrates setting the electronic device use controller to control the features of at least one electronic device according to the accepted access rights during the meeting, and the process ends.

At block 1006, if an invitee responds by requesting to adjust the access rights for the meeting request, then the process passes to block 1014. Block 1014 illustrates submitting the meeting adjustment request to the meeting manager. Next, block 1016 depicts a determination whether a response is received from the meeting manager. When a response is received from the meeting manager, the process returns to block 1004.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification specify the presence of stated features, integers, steps, operations, elements, and/or components, but not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the one or more embodiments of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the invention has been particularly shown and described with reference to one or more embodiments, it will be understood by those skilled in the art that various changes in form and detail may be made therein without departing from the spirit and scope of the invention.

What is claimed is:

1. A method in at least one computer system for specifying controlled access to the use of an electronic device, comprising:
sending a meeting request for a meeting to at least one invitee, wherein the meeting request specifies access rights to control use during the meeting of least one feature of a plurality of features of at least one electronic device associated with the at least one invitee; and
requiring the at least one invitee accept the access rights specified in the meeting request for controlling use of the at least one electronic device, wherein acceptance of the meeting request is conditional upon acceptance of the access rights.

2. The method according to claim 1, further comprising:
allowing the at least one invitee to negotiate for additional access rights prior to accepting the meeting request.

3. The method according to claim 1, further comprising:
scanning the at least one electronic device associated with the at least one invitee to identify the plurality of features;
comparing the plurality of features with a selection of features specified for control by the access rights;
identifying a first selection of features from among the plurality of features allowed for use during the meeting according to the access rights and a second selection of features from among the plurality of features disallowed from use during the meeting according to the access rights;
displaying the first selection of features and the second selection of features and notifying the invitee that acceptance of the meeting request is contingent on control of the second selection of features during the meeting; and
offering a selectable option for the at least one invitee to select at least one particular feature from among the second selection of features to request to add to the first selection of features.

4. The method according to claim 1, further comprising:
during the meeting specified by the meeting request, receiving a request from the at least one invitee for use of a particular feature not allowed by the access rights from among the plurality of features; and
responsive to a meeting administrator authorizing use of the particular feature during the meeting, adjusting the access rights for the electronic device to allow use of the particular feature.

5. The method according to claim 1, wherein sending a meeting request to at least one invitee, wherein the meeting request specifies access rights to control use during the meeting of least one feature of a plurality of features of at least one electronic device associated with the at least one invitee, further comprises:
sending the meeting request specifying access rights for controlling at least one of at least one network use feature from among the plurality of features of the electronic device, at least one application from among the plurality of features of the electronic device, and at least one hardware element from among the plurality of features of the electronic device.

6. The method according to claim 1 further comprising:
downloading a module to the at least one electronic device comprising the instructions for controlling the at least one feature of the device during the meeting; and
installing the module on the at least one electronic device.

7. The method according to claim 1 further comprising:
downloading a module to the at least one electronic device comprising the instructions for requesting the access rights during the meeting from a server via a network and controlling the at least one feature of the device during the meeting; and
installing the module on the at least one electronic device.

8. A system for specifying controlled access to the use of an electronic device, comprising:
a meeting manager for sending a meeting request for a meeting to at least one invitee, wherein the meeting request specifies access rights to control use during the meeting of least one feature of a plurality of features of at least one electronic device associated with the at least one invitee; and
the meeting manager for requiring the at least one invitee accept the access rights specified in the meeting request for controlling use of the at least one electronic device, wherein acceptance of the meeting request is conditional upon acceptance of the access rights.

9. The system according to claim 8, further comprising the meeting manager for allowing the at least one invitee to negotiate for additional access rights prior to accepting the meeting request.

10. The system according to claim 8, further comprising:
a feature scanner for scanning the at least one electronic device associated with the at least one invitee to identify the plurality of features;
a meeting scheduling controller for comparing the plurality of features with a selection of features specified for control by the access rights;
the meeting scheduling controller for identifying a first selection of features from among the plurality of features allowed for use during the meeting according to the access rights and a second selection of features from among the plurality of features disallowed from use during the meeting according to the access rights;
the meeting scheduling controller for displaying the first selection of features and the second selection of features and notifying the invitee that acceptance of the meeting request is contingent on control of the second selection of features during the meeting; and
the meeting scheduling controller for offering a selectable option for the at least one invitee to select at least one particular feature from among the second selection of features to request to add to the first selection of features.

11. The system according to claim 8, further comprising:
the meeting manager, during a meeting specified by the meeting request, for receiving a request from the at least one invitee for use of a particular feature not allowed by the access rights from among the plurality of features; and
the meeting manager, responsive to a meeting administrator authorizing use of the particular feature during the meeting, for adjusting the access rights for the electronic device to allow use of the particular feature.

12. The system according to claim 8, wherein the at least one feature controlled by the access rights is at least one of at least one network use feature from among the plurality of features, at least one application feature from among the plurality of features, and at least one hardware element feature from among the plurality of features.

13. The system according to claim 8 further comprising:
the meeting manager for downloading a module to the at least one electronic device comprising the instructions for controlling the at least one feature of the device during the meeting.

14. The system according to claim 8 further comprising:
the meeting manager for downloading a module to the at least one electronic device comprising the instructions for requesting the access rights during the meeting from a server via a network and controlling the at least one feature of the device during the meeting.

15. A computer program product for specifying controlled access to the use of an electronic device, the computer program product comprising:
a computer usable medium having computer usable program code embodied therewith, the computer usable program code comprising:
computer usable program code configured to:
send a meeting request for a meeting to at least one invitee, wherein the meeting request specifies access rights to control use during the meeting of least one feature of a plurality of features of at least one electronic device associated with the at least one invitee and
require the at least one invitee accept the access rights specified in the meeting request for controlling use of the at least one electronic device, wherein acceptance of the meeting request is conditional upon acceptance of the access rights.

16. The computer program product of claim 15, the computer usable program code further configured to allow the at least one invitee to negotiate for additional access rights prior to accepting the meeting request.

17. The computer program product of claim 15, the computer usable program code further configured to:
scan the at least one electronic device associated with the at least one invitee to identify the plurality of features;
compare the plurality of features with a selection of features specified for control by the access rights;
identify a first selection of features from among the plurality of features allowed for use during the meeting according to the access rights and a second selection of features from among the plurality of features disallowed from use during the meeting according to the access rights;
display the first selection of features and the second selection of features and notifying the invitee that acceptance of the meeting request is contingent on control of the second selection of features during the meeting; and
offer a selectable option for the at least one invitee to select at least one particular feature from among the second selection of features to request to add to the first selection of features.

18. The computer program product of claim 15, the computer usable program code further configured to:
during a meeting specified by the meeting request, receive a request from the at least one invitee for use of a particular feature not allowed by the access rights from among the plurality of features; and
responsive to a meeting administrator authorizing use of the particular feature during the meeting, adjust the access rights for the electronic device to allow use of the particular feature.

19. The computer program product of claim 15, the computer usable program code further configured to send the meeting request specifying access rights for controlling at least one of at least one network use feature from among the plurality of features, at least one application feature from among the plurality of features, and at least one hardware element feature from among the plurality of features.

20. The computer program product of claim 15, the computer usable program code further configured to download a module to the at least one electronic device comprising the instructions for controlling the at least one feature of the device during the meeting.
